(19) United States
(12) Patent Application Publication
(10) Pub. No.: US 2019/0338770 A1
(43) Pub. Date: Nov. 7, 2019

(54) Method for Producing a Housing of a Screw Compressor

(71) Applicant: KNORR-BREMSE Systeme fuer Nutzfahrzeuge GmbH, Muenchen (DE)

(72) Inventors: Gilles HEBRARD, Muenchen (DE); Jean-Baptiste MARESCOT, Muenchen (DE); Joerg MELLAR, Muenchen (DE); Thomas WEINHOLD, Muenchen (DE)

(73) Assignee: KNORR-BREMSE Systeme fuer Nutzfahrzeuge GmbH, Muenchen (DE)

(21) Appl. No.: 16/333,334

(22) PCT Filed: Sep. 19, 2017
(86) PCT No.: PCT/EP2017/073596

§ 371 Date: May 17, 2019

(30) Foreign Application Priority Data
Sep. 21, 2016 (DE) 10 2016 011 433.9
Feb. 28, 2017 (DE) 10 2017 104 087.0

(51) Int. Cl. F04C 2/28; B23B 51/00

(52) U.S. Cl. CPC F04C 2/28; B23B 51/009; F04C 2240/52; F04C 2240/30; F04C 2230/10

(57) ABSTRACT

A method produces at least one first screw bearing seat and at least one first inner wall region in a rotor housing. The rotor housing is part of a housing of a screw compressor. The method orients the rotor housing of the screw compressor, and produces the first screw bearing seat and the first inner wall region of the rotor housing in at least one joint production operation.

### BACKGROUND AND SUMMARY OF THE INVENTION

The present invention relates to a method for producing at least one screw bearing seat and at least one inner wall region of a rotor housing of a housing of a screw compressor.

Such methods for producing housings of a screw compressor, and correspondingly produced housings of screw compressors, are already known from the prior art.

DD 2003 49 A1 presents a device for end walls on screw-type machines having at least two screw rotors which are arranged parallel and which engage into one another in pairwise fashion, having a working chamber which is composed of a casing wall tightly surrounding the screw rotors and of end walls.

DE 37 37 358 A1 discloses a rotor housing for an internally mounted screw spindle pump, and corresponding production methods. Here, receiving bores of the screw spindle are provided in a housing body. For this purpose, disk-like material pieces which have the receiving bores of the screw spindle and which are composed of wear-resistant material are inserted into the housing. The wear-resistant material may in particular be ceramic, and may be arranged axially one behind the other in accordance with the lining length. The invention furthermore comprises a method for producing said housing, according to which the wear-resistant material pieces are cast into the housing body by means of plastic.

DE 40 16 841 A1 discloses a method for producing a rotor housing of a screw spindle pump. In order to avoid the production-induced difficulties that arise in the case of the previous production method by means of drilling and reaming of overlapping bores, the housing is centrally split, such that a change can be made from internal machining to external machining by means of profile milling or profile grinding.

DE 19 48 589 A1 presents a method for producing housings for screw pumps. Here, the production method has multiple steps, wherein the housing is produced in unmachined form with bores larger than the finished dimension, and in each case one relatively small mandrel or core is inserted into each bore. Subsequently, a curing plastic is introduced into the annular space between mandrel and bore wall, and the mandrel is pulled out after the plastic has cured.

In the case of hitherto known production methods for bearing seats for screws of screw compressors, multiple separate machining and clamping steps are required in particular owing to the bearings that are used, in the case of which steps it is also necessary for the housing as a whole in which the bearing seats are arranged to be rotated. The multiple separate machining and clamping steps of the production method also mean that it becomes difficult to attain the required accuracy in particular of the screw bearing seat and of the inner wall region of the rotor housing.

It is therefore the object of the present invention to advantageously further develop a method for producing a housing of a screw compressor of the type mentioned in the introduction, in particular such that the accuracy of the production method as a whole can be increased, and the complexity thereof can be reduced.

This object is achieved according to the invention by a method for producing a housing of a screw compressor, which method produces at least one first screw bearing seat and at least one first inner wall region in a rotor housing, wherein the rotor housing is a constituent part of a housing of a screw compressor. The method includes the steps of:
aligning the rotor housing of the screw compressor; and
manufacturing the first screw bearing seat and the first inner wall region of the rotor housing in at least one joint manufacturing process.

The invention is based on the underlying concept of producing both the first screw bearing seat and the first inner wall region of the rotor housing in at least one joint manufacturing process. The basis for the joint manufacturing process being implementable in the first place is the unilateral accessibility to the rotor housing, which in turn results from an adaptation or reduction in size of the diameter of the first screw bearing seat. As a result of joint manufacturing, at least one further manufacturing step that would inevitably result in the case of separate manufacture of the first inner wall region of the rotor housing and of the first screw bearing seat is eliminated. Furthermore, the first screw bearing seat and the first inner wall region of the rotor housing can, in particular owing to the joint manufacturing process, be manufactured in one clamping setup, whereby the clamping and assembly times and the associated costs can also be reduced. Furthermore, owing to the joint manufacturing process, the mutual alignment thereof and the accuracy thereof are improved in the form of narrower shape and position tolerances. Owing to the fact that the screw bearing seat and the inner wall region are of coaxial or substantially coaxial form, the rotor that is inserted into the screw bearing seat and, at this location, into the rotor housing can be positioned much more closely against the inner wall region of the rotor housing. There is no need here to allow for corresponding tolerances to have to be provided because manufacturing inaccuracies must be compensated. Rather, the rotor can be positioned here very closely against the inner wall region of the rotor housing. This has the effect that the compression performance of the screw compressor is improved. This is because losses are reduced by virtue of the gap between rotor and inner wall region of the rotor housing being relatively small, and in particular smaller than has been the case with manufacturing methods known from the prior art.

Provision may furthermore be made for the joint manufacturing process to comprise the following steps:
starting a manufacturing process of the first inner wall region of the rotor housing, wherein the first inner wall region of the rotor housing has a partially cylindrical form;
starting a manufacturing process of the first screw bearing seat during the manufacturing process of the first inner wall region of the rotor housing; and
jointly ending the joint manufacturing process of the first screw bearing seat and of the first inner wall region of the rotor housing.

The sequence of these manufacturing steps permits a highly precise joint manufacturing process which is easy to perform, because they permit the use of a replicating manufacturing method (for example profile milling)

It is furthermore conceivable in this context for the joint manufacturing process to be performed with a feed motion. Performing the joint manufacturing process for example with an axial feed motion is particularly simple and advantageous because the first inner wall region of the rotor housing and the first screw bearing seat can be manufactured by means of profile milling. The profile milling method ensures, in particular through the use of a stepped tool with multiple cutting edges, a precise coaxial alignment of the first inner wall region of the rotor housing and of the first screw bearing seat, which is particularly important for increasing the efficiency of the screw compressor. It is however likewise conceivable for the joint manufacturing process to be performed with a radial feed motion. The radial feed motion may be realized for example by means of a Wohlhaupter.

It is furthermore conceivable that, during the joint manufacturing process, a manufacturing direction runs from an open end of the rotor housing axially in the direction of an at least partially closed end of the rotor housing. Since the open end of the rotor housing has a larger opening diameter than the partially closed end thereof, the joint manufacturing process can be performed particularly advantageously proceeding from the open end into the interior of the rotor housing. The resulting simplified accessibility into the rotor housing throughout the entire joint manufacturing process thus contributes to the simplification thereof, or to the further optimization thereof.

Provision may furthermore be made whereby the joint manufacturing process is performed by means of at least one cutting manufacturing process, in particular by means of milling. Through the use of a cutting manufacturing method such as for example milling, it is possible within a reasonable timeframe for the production of the first inner wall region and of the first screw bearing seat to be performed particularly advantageously with high accuracy and at likewise reasonable cost. The cutting manufacturing method is however not restricted to milling, in particular profile milling, but rather may for example also be performed by erosion, turning, reaming, grinding or drilling or combinations of these.

It is furthermore conceivable that the cutting manufacturing process is performed by means of at least one cutting manufacturing tool, wherein the cutting manufacturing tool is rotated. Owing to the use of only one cutting manufacturing tool in the joint manufacturing process, the manufacturing duration can be shortened, because additional manufacturing steps can thus be omitted. Furthermore, manufacturing tools normally already have extremely narrow shape and dimensional tolerances, such that manufacturing using only one manufacturing tool has in particular a positive effect on the position tolerances of the first screw bearing seat in relation to the first inner wall region of the rotor housing.

It is likewise conceivable for the cutting manufacturing tool to be formed as a cutting, rotationally symmetrical stepped tool. The joint manufacturing process of first inner wall region and first screw bearing seat can be performed in the first place through the use of the rotationally symmetrical stepped tool, because their geometries to be manufactured inevitably result from the outer contour of the stepped tool, which geometries must likewise be formed in stepped fashion for optimum functional fulfilment by the screw compressor. The stepped tool may be formed as a stepped milling tool, in particular as a stepped profile milling tool, as a stepped reamer or in some other suitable manner. The stepped tool may furthermore be formed from steel, in particular HSS steel, hard metal, from steel with a hard metal coating, from steel with integrated hard metal cutting plates, or from some other suitable materials or material and/or component combinations.

Furthermore, provision may be made whereby the stepped tool has a first portion with a first diameter and has a second portion with a second diameter, wherein the first diameter is smaller than the second diameter. As already discussed above, the first inner wall region and the first screw bearing seat of the rotor housing must be of stepped form relative to one another with regard to the diameter. Since the first screw bearing seat is of circular form and the first inner wall region of the rotor housing is of at least partially cylindrical form, the manufacture thereof by means of the stepped tool which has a first and a second portion with respectively different diameters is particularly advantageous.

It is furthermore conceivable that the first portion of the stepped tool is of singly stepped form, such that the first portion has a first sub-portion with the first diameter and has a second sub-portion with a third diameter, wherein the third diameter is smaller than the first diameter. For the case that the first portion of the stepped tool additionally forms a further step, or in other words is divided into a first sub-portion and a second sub-portion, this yields further advantageous configuration possibilities for the rotor housing, such as for example a housing shoulder for accommodating axial bearing forces, which housing shoulder axially delimits in particular the first screw bearing seat at one side.

It is additionally conceivable that the first screw bearing seat is manufactured by means of the first portion of the stepped tool and the first inner wall region of the rotor housing is manufactured by means of the second portion of the stepped tool. The first inner wall region of the rotor housing should normally have a larger diameter than the first screw bearing seat. Thus, the manufacture of the first screw bearing seat by means of the first portion and of the first inner wall region of the rotor housing by means of the second portion, which has a relatively large diameter, of the stepped tool is particularly advantageous. Finally, the respective diameters of the first and second portions of the stepped tool can be adapted to the desired respective diameter of the first screw bearing seat and of the first inner wall region of the rotor housing.

Provision may furthermore be made whereby a spacing between a central axis of the first screw bearing seat and a central axis of the first inner wall region of the rotor housing is less than approximately 0.05 mm, in particular less than approximately 0.01 mm. The efficiency of the screw compressor is significantly dependent on so-called overflow losses, which in turn are dependent inter alia on the spacing between the central axes of the first screw bearing seat and of the first inner wall region of the rotor housing, such that, by means of a reduction of the spacing of the two central axes discussed above, the efficiency of the screw compressor can be improved.

It is also conceivable that the rotor housing of the housing of the screw compressor has at least one second screw bearing seat and at least one second inner wall region, which are manufactured substantially by means of the identical production method and by means of an at least partially identical stepped tool in relation to the first screw bearing seat and the first inner wall region of the rotor housing. The first and second inner wall region of the rotor housing and the first and second screw bearing seat serve in particular for the partial mounting and radial encasement of the screws of the screw compressor. Within a screw compressor, use is normally made of at least two screws, such that the joint manufacturing process of the first screw bearing seat and of the first inner wall region of the rotor housing can consequently be adapted in a very simple and advantageous manner to the second screw bearing seat and the second inner wall region of the rotor housing.

Further details and advantages of the invention will now be discussed in more detail on the basis of an exemplary embodiment illustrated in the drawings.

### BRIEF DESCRIPTION OF THE DRAWINGS

FIG. 1 shows a schematic sectional illustration of an exemplary embodiment of a screw compressor according to the invention, the housing of which is produced by means of a production method according to the invention;

FIG. 2 shows a sectional illustration through the housing, produced by means of the production method according to the invention, of the screw compressor as per FIG. 1 during the joint manufacturing process of first screw bearing seat and first inner wall region;

FIG. 3 shows a sectional illustration through the housing, produced by means of the production method according to the invention, of the screw compressor as per FIG. 1 during the joint manufacturing process of second screw bearing seat and second inner wall region;

FIG. 4 shows a sectional illustration through a housing, produced by means of a conventional, separately performed production method, of a screw compressor during a manufacturing process of a second inner wall region and of a transition bore; and

FIG. 5 shows a sectional illustration through the housing, produced by means of the conventional, separately performed production method, of a screw compressor as per FIG. 4, during a manufacturing process of a second screw bearing seat.

### DETAILED DESCRIPTION OF THE DRAWINGS

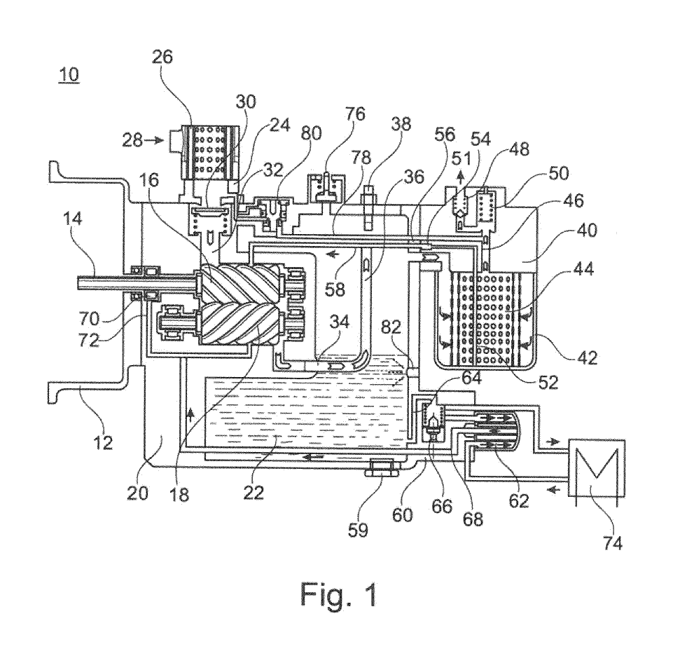

FIG. 1 shows, in a schematic sectional illustration, a screw compressor 10 in the context of an exemplary embodiment of the present invention, the housing 20 of which screw compressor is produced by means of the production method according to the invention.

The screw compressor 10 has a fastening flange 12 for the mechanical fastening of the screw compressor 10 to a drive (not shown in any more detail here) in the form of an electric motor.

What is shown, however, is the input shaft 14, by which the torque from the electric motor is transmitted to one of the two screws 16 and 18, specifically the screw 16.

The screw 18 meshes with the screw 16 and is driven by means of the latter.

The screw compressor 10 has a housing 20 in which the main components of the screw compressor 10 are accommodated.

The housing 20 is filled with oil 22.

At the air inlet side, an inlet connector 24 is provided on the housing 20 of the screw compressor 10. The inlet connector 24 is in this case designed such that an air filter 26 is arranged at said inlet connector. Furthermore, an air inlet 28 is provided radially on the air inlet connector 24.

In the region between the inlet connector 24 and the point at which the inlet connector 24 joins to the housing 20, there is provided a spring-loaded valve insert 30, which is designed here as an axial seal.

This valve insert 30 serves as a check valve.

Downstream of the valve insert 30, there is provided an air feed channel 32 which feeds the air to the two screws 16, 18.

At the outlet side of the two screws 16, 18, there is provided an air outlet pipe 34 with a riser line 36.

In the region of the end of the riser line 36, there is provided a temperature sensor 38 by means of which the oil temperature can be monitored.

Also provided in the air outlet region is a holder 40 for an air deoiling element 42.

In the assembled state, the holder 40 for the air deoiling element has the air deoiling element 42 in the region facing toward the base (as also shown in FIG. 1).

Also provided, in the interior of the air deoiling element 42, is a corresponding filter screen or known filter and oil separation devices 44, which will not be specified in any more detail.

In the central upper region in relation to the assembled and operationally ready state (that is to say as shown in FIG. 1), the holder for the air deoiling element 42 has an air outlet opening 46 which leads to a check valve 48 and a minimum pressure valve 50. The check valve 48 and the minimum pressure valve 50 may also be formed in one common combined valve.

The air outlet 51 is provided downstream of the check valve 48.

The air outlet 51 is generally connected to correspondingly known compressed-air consumers.

In order for the oil 22 that is situated and separated off in the air deoiling element 42 to be returned into the housing 20 again, a riser line 52 is provided which has a filter and check valve 54 at the outlet of the holder 40 for the air deoiling element 42 at the transition into the housing 20.

A nozzle 56 is provided, downstream of the filter and check valve 54, in a housing bore. The oil return line 58 leads back into approximately the central region of the screw 16 or of the screw 18 in order to feed oil 22 thereto again.

An oil drain screw 59 is provided within the base region, in the assembled state, of the housing 20. By means of the oil drain screw 59, a corresponding oil outflow opening can be opened, via which the oil 22 can be drained.

Also provided in the lower region of the housing 20 is the attachment piece 60 to which the oil filter 62 is fastened. Via an oil filter inlet channel 64, which is arranged in the housing 20, the oil 22 is conducted firstly to a thermostat valve 66.

Instead of the thermostat valve 66, it is possible for an open-loop and/or closed-loop control device to be provided by means of which the oil temperature of the oil 22 situated in the housing 20 can be monitored and set to a setpoint value.

Downstream of the thermostat valve 66, there is then the oil inlet of the oil filter 62, which, via a central return line 68, conducts the oil 22 back to the screw 18 or to the screw 16 again, and also to the oil-lubricated bearing 70 of the shaft 14. Also provided in the region of the bearing 70 is a nozzle 72, which is provided in the housing 20 in conjunction with the return line 68.

The cooler 74 is connected to the attachment piece 60.

In the upper region of the housing 20 (in relation to the assembled state), there is situated a safety valve 76, by means of which an excessively high pressure in the housing 20 can be dissipated.

Upstream of the minimum pressure valve 50, there is situated a bypass line 78, which leads to a relief valve 80. Via said relief valve 80, which is activated by means of a connection to the air feed 32, air can be returned into the region of the air inlet 28. In this region, there may be provided a ventilation valve (not shown in any more detail) and also a nozzle (diameter constriction of the feeding line).

Furthermore, approximately at the level of the line 34, an oil level sensor 82 may be provided in the outer wall of the housing 20. Said oil level sensor 82 may for example be an optical sensor, and may be designed and configured such that, on the basis of the sensor signal, it can be identified whether the oil level during operation is above the oil level sensor 82 or whether the oil level sensor 82 is exposed, and thus the oil level has correspondingly fallen.

In conjunction with this monitoring, it is also possible for an alarm unit to be provided which outputs or transmits a corresponding error message or warning message to the user of the system.

The function of the screw compressor 10 shown in FIG. 1 is as follows.

Air is fed via the air inlet 28 and passes via the check valve 30 to the screws 16, 18, where the air is compressed. The compressed air-oil mixture, which, having been compressed by a factor of between 5 and 16 downstream of the screws 16 and 18, rises through the outlet line 34 via the riser pipe 36, is blown directly onto the temperature sensor 38.

The air, which still partially carries oil particles, is then conducted via the holder 40 into the air deoiling element 42 and, if the corresponding minimum pressure is attained, passes into the air outlet line 51.

The oil 22 situated in the housing 20 is kept at operating temperature via the oil filter 62 and possibly via the heat exchanger 74.

If no cooling is necessary, the heat exchanger 74 is not used and is also not activated.

The corresponding activation is performed by means of the thermostat valve 66. After purification in the oil filter 62, oil is fed via the line 68 to the screw 18 or to the screw 16, and also to the bearing 70. The screw 16 or the screw 18 is supplied with oil 22 via the return line 52, 58, and the purification of the oil 22 takes place here in the air deviling element 42.

By means of the electric motor (not shown in any more detail), which transmits its torque via the shaft 14 to the screw 16, which in turn meshes with the screw 18, the screws 16 and 18 of the screw compressor 10 are driven.

By means of the relief valve 80 (not shown in any more detail), it is ensured that the high pressure that prevails for example at the outlet side of the screws 16, 18 in the operational state cannot be enclosed in the region of the feed line 32, and that, instead, in particular during the start-up of the compressor, there is always a low inlet pressure, in particular atmospheric pressure, prevailing in the region of the feed line 32. Otherwise, upon a start-up of the compressor, a very high pressure would initially be generated at the outlet side of the screws 16 and 18, which would overload the drive motor.

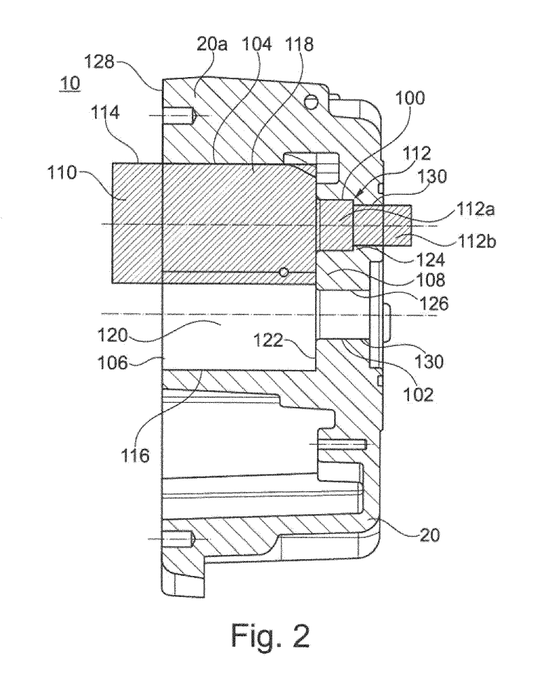

FIG. 2 shows a sectional illustration through the screw compressor 10 according to the invention as per FIG. 1, the housing 20 of which is produced by means of the production method according to the invention.

In FIG. 2, the housing 20 is illustrated during the joint manufacturing process of a first screw bearing seat 100 and of a first inner wall region 104.

The housing 20 has a rotor housing 20a.

The rotor housing 20a is of substantially pot-shaped form.

The rotor housing 20a has a first and a second screw bearing seat 100, 102.

The first inner wall region 104 is situated within the rotor housing 20a.

The first inner wall region 104 has a partially cylindrical form.

The rotor housing 20a furthermore has an open end 106 and an oppositely situated partially closed end 108.

During the joint manufacturing process, a stepped tool 110 for the first screw bearing seat 100 is arranged within the rotor housing 20a.

The stepped tool 110 has a first portion 112.

Furthermore, the first portion 112 of the stepped tool 110 for the first screw bearing seat 100 has a first sub-portion 112a and a second sub-portion 112b.

The stepped tool 110 has a second portion 114.

Furthermore, the rotor housing 20a is an integral constituent part of the housing 20 of the screw compressor 10.

A second inner wall region 116 is also situated within the rotor housing 20a.

The second inner wall region 116 has a partially cylindrical form.

In the interior of the rotor housing 20a, there are furthermore formed two screw bores 118, 120 for the two screws 16, 18.

The two screw bores 118, 120 are delimited radially by the first and second inner wall regions 104, 116.

Axially, the two screw bores 118, 120 are delimited by an inner end side 122 of the partially closed end 108 of the rotor housing 20a.

In the inner end side 122 of the partially closed end 108 of the rotor housing 20a, the first and the second screw bearing seats 100, 102 are formed in perpendicular to said inner end side.

The first and second screw bearing seats 100, 102 are formed substantially as cylindrical passage bores 124, 126 in the partially closed end 108 of the rotor housing 20a.

The central axes of the first and of the second screw bearing seat 100, 102 are aligned substantially parallel to one another.

The spacing between the central axis of the first screw bearing seat 100 and a central axis of the first inner wall region 104 is less than approximately 0.01 mm.

The spacing between the central axis of the second screw bearing seat 102 and a central axis of the second inner wall region 116 is likewise less than approximately 0.01 mm.

The first screw bearing seat 100 is formed as a singly stepped passage bore 124 with a first, relatively large diameter as first bearing seat portion.

The second portion of the passage bore 124 with the relatively small diameter is formed as a first transition bore and extends from the bearing seat portion to an outer surface of the partially closed end 108 of the rotor housing 20a.

The second screw bearing seat 102 is formed as a non-stepped passage bore 126 with a continuously uniform diameter dimension.

The non-stepped passage bore 126 is divided axially into a second bearing seat portion and a second transition bore.

The second transition bore extends from the second bearing seat portion to an outer surface of the partially closed end 108 of the rotor housing 20a.

The open end 120 of the rotor housing 20a has a planar surface 128 which is oriented perpendicular to the central axes of the two screw bearing seats 100, 102.

As per FIG. 2, during the joint manufacturing process, a cutting manufacturing tool 110 is arranged within the rotor housing 20a.

The cutting manufacturing tool 110 for the first screw bearing seat 100 is formed as a cutting, rotationally symmetrical stepped tool 110.

The stepped tool 110 thus has a first portion 112 with a first diameter.

The stepped tool 110 has a second portion 114 with a second diameter, wherein the first diameter is smaller than the second diameter.

As per FIG. 2, the first portion 112 of the stepped tool 110 for the first screw bearing seat 100 is additionally of singly stepped form.

The first portion 112 thus has a first sub-portion 112a with the first diameter and has a second sub-portion 112b with a third diameter, wherein the third diameter is smaller than the first diameter.

The stepped tool 110 for the first screw bearing seat 100 is consequently composed of a first, a second and a third cylinder, which are connected integrally and coaxially by means of their respective end sides facing toward the other cylinders.

The stepped tool 110 has in each case one tool shoulder at the transition between the first, second and third cylinder.

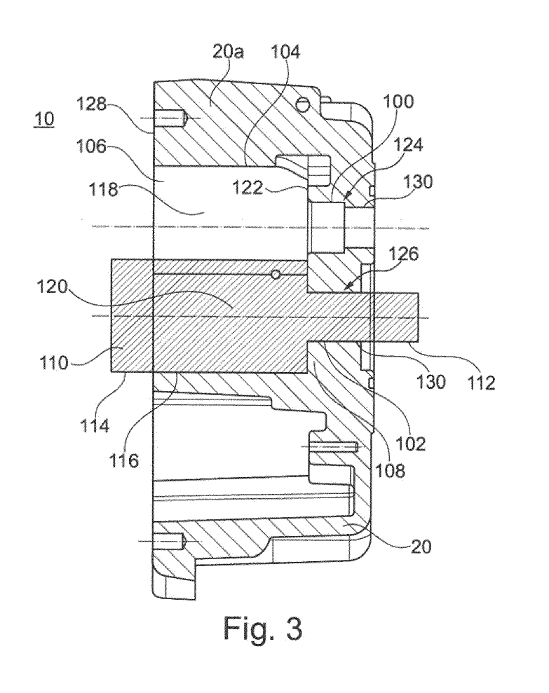

FIG. 3 shows a sectional illustration through the screw compressor 10 according to the invention as per FIG. 1, the housing 20 of which is produced by means of the production method according to the invention.

In FIG. 3, the housing 20 is illustrated during the joint manufacturing process of the second screw bearing seat 102 and of the second inner wall region 116.

The rotor housing 20a has all the structural features of the rotor housing 20a as per FIG. 2.

The stepped tool 110 for the second screw bearing seat 102 likewise has all of the structural features of the stepped tool 110 for the first screw bearing seat 100 as per FIG. 2, with the exception that the first portion 112 of the stepped tool 110 is of non-stepped form, such that it has substantially the first diameter along its axial extent.

With regard to the production of the housing 20 of the screw compressor 10, the following procedure is followed.

Firstly, the rotor housing 20a of the screw compressor 10 is aligned.

The alignment of the rotor housing 20a is realized by means of the clamping of the housing 20 on a machine tool, for example a milling machine.

Subsequently, the manufacture of the first screw bearing seat 100 and of the first inner wall region 104 of the rotor housing 20a is performed in a joint manufacturing process.

The joint manufacturing process is performed by means of a milling process.

The milling process is performed by means of a profile milling process.

Furthermore, the milling process is performed by means of a cutting manufacturing tool 110 in the form of a stepped tool 110.

The cutting manufacturing tool 110 is formed as a singly or doubly stepped profile miller.

The cutting manufacturing tool 110 is rotated during the joint manufacturing process.

The joint manufacturing process starts with a manufacturing process of the first inner wall region 104 of the rotor housing 20a.

The joint manufacturing process is furthermore performed with a feed motion.

This gives rise, during the joint manufacturing process, to a manufacturing direction which runs from the open end 106 of the rotor housing 20a axially in the direction of the at least partially closed end 108 of the rotor housing.

For this purpose, the first portion 112 of the stepped tool 110 firstly plunges into the first screw bore 118, which has for example already been provisionally formed into the rotor housing 20a in a prior production process.

The first portion 112 of the stepped tool 110 subsequently plunges increasingly further into the first screw bore 118 in accordance with the set feed motion, until the tool shoulder between the first and second portions 112, 114 and the planar surface 128 of the open end 106 of the rotor housing 20a lie in a plane.

The manufacture of the first inner wall region 104 of the rotor housing 20a is then additionally started by means of the second portion 114 of the stepped tool 110.

During the manufacturing process of the first inner wall region 104 of the rotor housing 20a, a manufacturing process of the first screw bearing seat 100 is also started.

Here, the first screw bearing seat 100 is manufactured by means of the first portion 112 of the stepped tool 110.

The stepped tool 110 is moved with the set feed motion axially in the manufacturing direction into the rotor housing interior until the required shape contours of the first inner wall region 104 and of the first screw bearing seat 100 have been formed.

As a further manufacturing step, the stepped tool 110 may additionally manufacture a sub-region of the inner end side 122 of the partially closed end 108 by means of the tool shoulder between the first and second portions 112, 114.

Subsequently, the joint manufacturing process of the first screw bearing seat 100 and of the first inner wall region 104 of the rotor housing 20a is jointly ended.

The joint ending involves the full retraction of the stepped tool 110 out of the housing interior of the rotor housing 20a counter to the manufacturing direction.

The stepped tool 110 may be rotated during the full retraction.

The production of the second screw bearing seat 102 and of the second inner wall region 116 is performed substantially by means of the identical production method of the first screw bearing seat 100 and of the first inner wall region 104 of the rotor housing 20a and by means of the stepped tool 110 described in FIG. 3.

Owing to the joint manufacturing process, it is thus possible for the manufacture of the first and second screw bearing seats 100, 102 and of the first and second inner wall regions 104, 116 of the rotor housing 20a to be performed in one clamping setup on a milling machine.

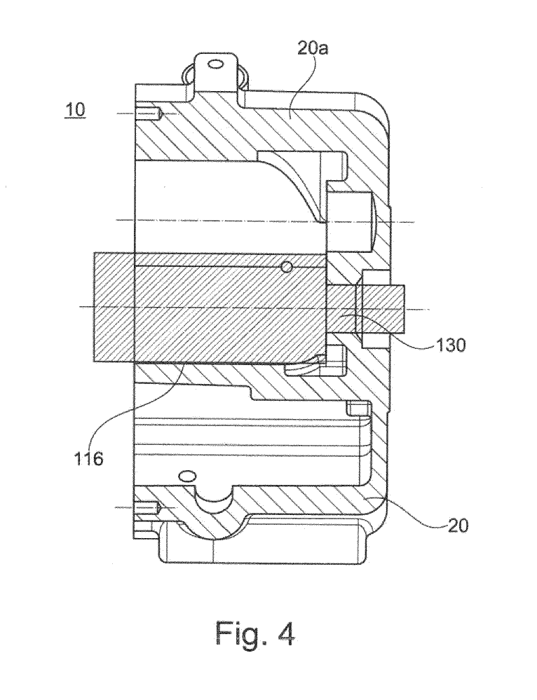

FIG. 4 shows a sectional illustration through a housing 20, produced by means of a conventional, separate production method, of a screw compressor 10 during a manufacturing process of a second inner wall region 116 and of a transition bore 130.

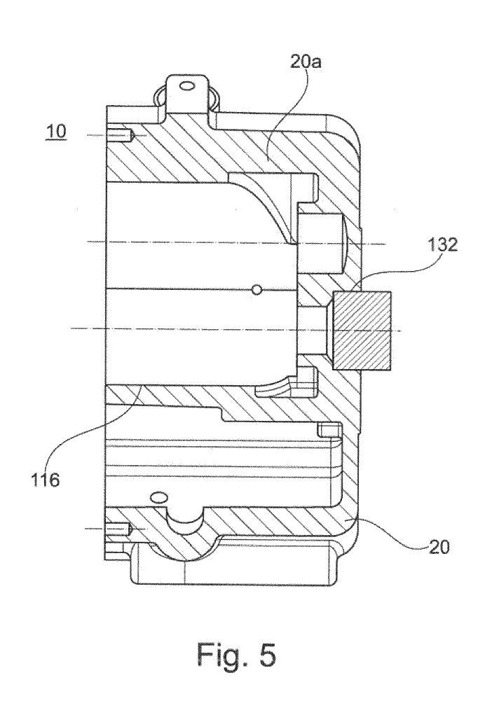

FIG. 5 shows a sectional illustration through the housing 20, produced by means of the conventional, separate production method, of the screw compressor 10 as per FIG. 4, during a separately performed manufacturing process of an outer screw bearing seat 132, wherein the misalignment between the central axes of outer screw bearing seat 132 and second inner wall region 116 can be seen.

### LIST OF REFERENCE SIGNS

10 Screw compressor
12 Fastening flange
14 Input shaft
16 Screw
18 Screw
20 Housing
20a Rotor housing
22 Oil
24 Inlet connector
26 Air filter
28 Air inlet
30 Valve insert
32 Air feed channel
34 Air outlet pipe
36 Riser line
38 Temperature sensor
40 Holder for an air deoiling element
42 Air deoiling element
44 Filter screen or known filter or oil separation devices
46 Air outlet opening
48 Check valve
50 Minimum pressure valve
51 Air outlet
52 Riser line
54 Filter and check valve
56 Nozzle
58 Oil return line
59 Oil drain screw
60 Attachment piece
62 Oil filter
64 Oil filter inlet channel
66 Thermostat valve
68 Return line
70 Bearing
72 Nozzle
74 Cooler, heat exchanger
76 Safety valve
78 Bypass line
80 Relief valve
82 Oil level sensor
100 First screw bearing seat
102 Second screw bearing seat
104 First inner wall region of the rotor housing
106 Open end of the rotor housing
108 Partially closed end of the rotor housing
110 Manufacturing tool or stepped tool
112 First portion of the stepped tool
112a First sub-portion of the stepped tool
112b Second sub-portion of the stepped tool
114 Second portion of the stepped tool
116 Second inner wall region
118 First screw bore
120 Second screw bore
122 Inner end side
124 Stepped passage bore
126 Non-stepped passage bore
128 Planar surface of the open end
130 Transition bore
132 Outer screw bearing seat

1-12. (canceled)

13. A method for producing at least one first screw bearing seat and at least one first inner wall region in a rotor housing, wherein the rotor housing is a constituent part of a housing of a screw compressor, the method comprising the steps of:
aligning the rotor housing of the screw compressor; and
manufacturing the first screw bearing seat and the first inner wall region of the rotor housing in at least one joint manufacturing process.

14. The method as claimed in claim 13, wherein
the joint manufacturing process comprises the steps of:
starting a manufacturing process of the first inner wall region of the rotor housing, wherein the first inner wall region of the rotor housing has a partially cylindrical form;
starting a manufacturing process of the first screw bearing seat during the manufacturing process of the first inner wall region of the rotor housing; and
jointly ending the joint manufacturing process of the first screw bearing seat and of the first inner wall region of the rotor housing.

15. The method as claimed in claim 14, wherein
the joint manufacturing process is performed with a feed motion.

16. The method as claimed in claim 14, wherein
during the joint manufacturing process, a manufacturing direction runs from an open end of the rotor housing axially in the direction of an at least partially closed end of the rotor housing.

17. The method as claimed in claim 13, wherein
during the joint manufacturing process, a manufacturing direction runs from an open end of the rotor housing axially in the direction of an at least partially closed end of the rotor housing.

18. The method as claimed in claim 13, wherein
the joint manufacturing process is performed by at least one cutting manufacturing process.

19. The method as claimed in claim 18, wherein
the cutting manufacturing process is performed by at least one cutting manufacturing tool, wherein the cutting manufacturing tool is rotated.

20. The method as claimed in claim 19, wherein
the cutting manufacturing tool is formed as a cutting, rotationally symmetrical stepped tool.

21. The method as claimed in claim 20, wherein
the stepped tool has a first portion with a first diameter and has a second portion with a second diameter, wherein the first diameter is smaller than the second diameter.

22. The method as claimed in claim 21, wherein
the first portion of the stepped tool is of singly stepped form, such that the first portion has a first sub-portion with the first diameter and has a second sub-portion with a third diameter, wherein the third diameter is smaller than the first diameter.

23. The method as claimed in claim 22, wherein
the first screw bearing seat is manufactured by the first portion of the stepped tool and the first inner wall region of the rotor housing is manufactured by the second portion of the stepped tool.

24. The method as claimed in claim 13, wherein
a spacing between a central axis of the first screw bearing seat and a central axis of the first inner wall region of the rotor housing is less than approximately 0.05 mm.

25. The method as claimed in claim 13, wherein
a spacing between a central axis of the first screw bearing seat and a central axis of the first inner wall region of the rotor housing is less than approximately 0.01 mm.

26. The method as claimed in claim 13, wherein
the rotor housing of the housing of the screw compressor has at least one second screw bearing seat and at least one second inner wall region, which are manufactured substantially by an identical production method and by an at least partially identical stepped tool in relation to the first screw bearing seat and the first inner wall region of the rotor housing.
